(19) United States
(12) Patent Application Publication
(10) Pub. No.: US 2007/0283084 A1
(43) Pub. Date: Dec. 6, 2007

(54) MEMORY AND REDUNDANCY REPAIR METHOD THEREOF

(75) Inventors: Ming-Cheng Chiu, Tainan County (TW); Wei-Hung Chang, Tainan County (TW); Yaw-Guang Chang, Tainan County (TW)

Correspondence Address: J C PATENTS, INC., 4 VENTURE, SUITE 250, IRVINE, CA, 92618, US

(73) Assignee: HIMAX TECHNOLOGIES LIMITED, Tainan County (TW)

(21) Appl. No.: 11/751,947

(22) Filed: May 22, 2007

(30) Foreign Application Priority Data
May 30, 2006 (TW) 95119120

(51) Int. Cl. G06F 13/00

(52) U.S. Cl. 711/104

(57) ABSTRACT

A memory and the redundancy repair method thereof are provided. The memory includes a first memory unit and a second memory unit. The first memory unit includes a static random access memory (SRAM) unit and a redundancy unit, and the second memory unit is coupled to the first memory unit. If there is at least a damaged memory block in the SRAM unit, at least a redundancy block is determined corresponding the damaged memory block in the redundancy unit, and the address of the damaged memory block and the address of the redundancy block are stored in the second memory unit.

### CROSS-REFERENCE TO RELATED APPLICATION

This application claims the priority benefit of Taiwan application serial no. 95119120, filed on May 30, 2006. All disclosure of the Taiwan application is incorporated herein by reference.

### BACKGROUND OF THE INVENTION

1. Field of the Invention

The present invention relates to a memory. More particularly, the present invention relates to a static random access memory (SRAM) with redundancy repair capacity.

2. Description of Related Art

As mobile communication apparatuses come to need larger data storage capacity, the requirement on an SRAM with large capacity and high integration become higher accordingly. However, for an SRAM, once one of the memory blocks is damaged, the whole memory must be discarded.

For a memory with a higher integration, it is more difficult to enhance the process yield thereof. If damaged blocks can be repaired or replaced individually, the process yield may not be greatly reduced because of the uncertainty of the process, thereby reducing the manufacturing cost.

### SUMMARY OF THE INVENTION

Accordingly, one object of the present invention is to provide a memory, wherein the address of a damaged memory block in an SRAM and the address of a corresponding redundancy block are stored in a one time program memory (OTP), and the process yield of the SRAM is greatly enhanced through the redundancy repair technology.

Another object of the present invention is to provide a redundancy repair method of the memory. The address of the damaged memory block in an SRAM and the address of the corresponding redundancy block are stored in a one time program memory (OTP), and the process yield of the SRAM is greatly enhanced through the redundancy repair technology.

In order to achieve the aforementioned and other objects, the present invention provides a memory, which comprises a first memory unit and a second memory unit. The first memory unit comprises an SRAM unit and a redundancy unit. The second memory unit is coupled to the first memory unit. If the SRAM unit comprises at least one damaged memory block, a redundancy block in the redundancy unit corresponding to the damaged memory block is determined, and the address of the damaged memory block and the address of the redundancy block are stored in the second memory unit.

In order to achieve the aforementioned and other objects, the present invention provides a redundancy repair method of the memory, wherein the memory comprises a first memory unit and a second memory unit. The first memory unit comprises the SRAM unit and the redundancy unit. The second memory unit is coupled to the first memory unit. The method comprises: first, testing the SRAM unit; then, when the SRAM unit comprises at least a damaged memory block, determining at least a redundancy block in the redundancy unit corresponding to the damaged memory block; and finally, storing the address of the damaged memory block and the address of the redundancy block.

According to one embodiment of the present invention, the first memory unit comprises an internal read unit, which is coupled to the SRAM unit and the redundancy block and reads the data stored in the first memory unit for transmission to a display according to the address data stored in the second memory unit.

According to one embodiment of the present invention, the first memory unit comprises an external read/write unit, which is coupled to the SRAM unit and the redundancy block and determines the address of reading and writing data from/to the first memory unit according to the address data stored in the second memory unit.

According to one embodiment of the present invention, the aforementioned second memory unit can be a one time program memory.

Since the small-area one time program memory (OTP) is employed and the redundancy repair technology is integrated, in the application of SRAM, the process yield of the SRAM may be greatly enhanced. Furthermore, two read/write interfaces are integrated, i.e., the interfaces respectively applicable to reading and writing the data in a host and for reading the data for transmission to a display, such that the SRAM of the present invention is more applicable for a mobile communication device.

In order to the make aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an SRAM according to one embodiment of the present invention.

FIG. 2 is a flow chart of a redundancy repair method of the SRAM in FIG. 1 according to one embodiment of the present invention.

### DESCRIPTION OF EMBODIMENTS

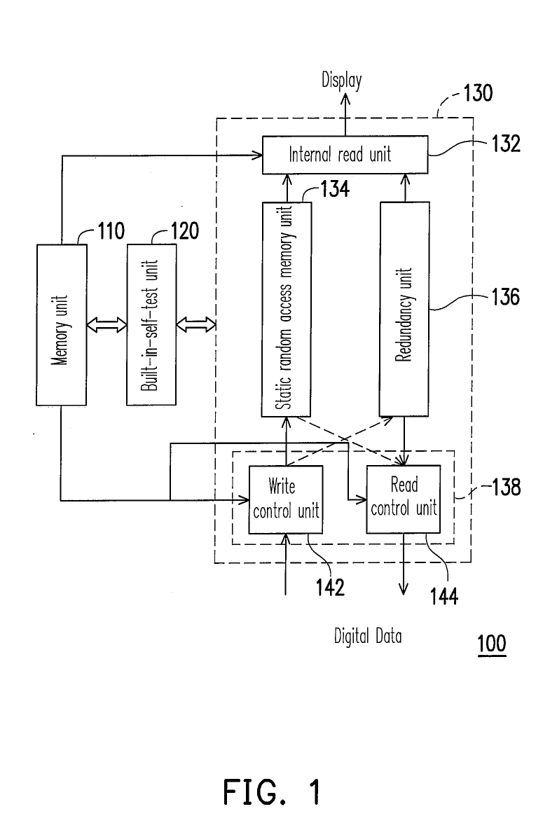

Next, technical features of the present invention are illustrated using an SRAM as an embodiment. FIG. 1 is a block diagram of an SRAM according to one embodiment of the present invention. The SRAM 100 comprises memory units 110 and 130 and a built-in-self-test (BIST) unit 120. In the present embodiment, the memory unit 110 may be a one time program memory. The memory unit 130 still comprises an SRAM unit 134, a redundancy unit 136, an internal read unit 132, and an external read/write unit 138. The redundancy unit 136 also comprises a plurality of redundancy blocks, i.e., the redundancy unit 136 may also be used as an SRAM. The external read/write unit 138 comprises a write control unit 142 and a read control unit 144.

The SRAM unit 134 and the redundancy unit 136 are coupled between the internal read unit 132 and the external read/write unit 138, respectively, and the memory unit 110 is coupled between the internal read unit 132 and the external read/write unit 138. The BIST unit 120 is coupled between the memory unit 110 and the memory unit 130, which is responsible for storing the test results of the memory unit 130 into the memory unit 110.

The BIST unit 120 only operates during a testing period, mainly for testing whether a damaged memory block exists in the SRAM unit 134, and storing the corresponding address data into the memory unit 110. When a damaged memory block is detected in the SRAM unit 134, a redundancy block of the redundancy unit 136 corresponding to the damaged memory block is determined according to the detection. Meanwhile, the address data of the redundancy block is stored in the memory unit 110. After the detection, the BIST unit 120 stores the address data of all damaged memory blocks in the SRAM unit 134 and the address data of the redundancy blocks corresponding to the damaged memory blocks into the memory unit 110. In other words, the address data of the damaged memory blocks in the SRAM unit 134 and the address data of the corresponding redundancy blocks in the redundancy unit 136 are stored in the memory unit 110. In the present invention, the addresses of the redundancy blocks corresponding to individual damaged memory blocks may be obtained by the BIST unit 120.

The external read/write unit 138 is responsible for reading and writing digital data from/into the SRAM unit 134 and determining the read/write address of the digital data according to the address data in the memory unit 110. The external read/write unit 138 comprises the write control unit 142 and the read control unit 144, which are responsible for the writing and reading operations, respectively. As for data storage, when the write control unit 142 wants to write digital data into the SRAM unit 134, the storage address of the digital data is determined according to the address data stored in the memory unit 110. The redundancy block in the redundancy unit 136 is used to replace the damaged memory block in the SRAM unit 134, thereby completing the storage of the digital data. Therefore, even though the SRAM unit 134 has at least a damaged memory block, it still can operate normally and store data as long as the redundancy unit 136 is used. The redundancy unit 136 is used to replace the damaged memory block in the SRAM unit 134 and the corresponding address data is stored in the memory unit 110, such that the SRAM unit 134 may operate normally.

With respect to reading operation, the read control unit 144 reads desired data from the SRAM unit 134 and the redundancy unit 136 according to the address data stored in the memory unit 110. The internal read unit 132 is also responsible for reading data, and mainly reads data from the SRAM unit 134 and the redundancy unit 136 for transmission to a display, such as a driving circuit of a liquid crystal display panel. The internal read unit 132 also reads the desired data from the SRAM unit 134 and the redundancy unit 136 according to the address data stored in the memory unit 110.

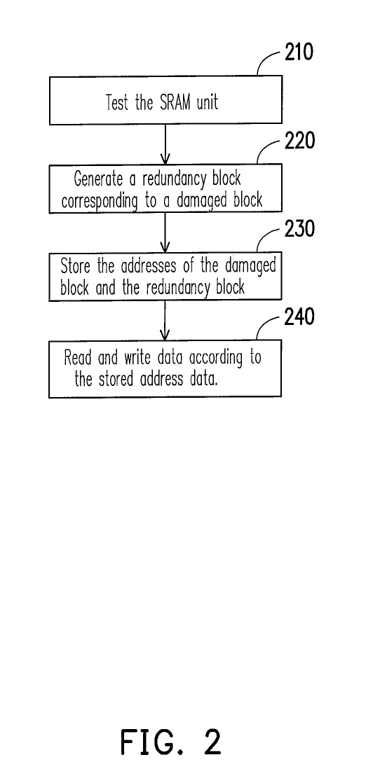

FIG. 2 is a flow chart of the redundancy repair method of the SRAM in FIG. 1 according to another embodiment of the present invention. Referring to FIGS. 1 and 2, the SRAM 100 comprises the memory units 110 and 130, and the memory unit 130 comprises the static random access memory (SRAM) unit 134 and the redundancy unit 136, wherein the memory unit 110 is coupled to the memory unit 130. The method comprises the steps as follows.

First, in Step 210, the BIST unit 120 tests the SRAM unit 134 and finds the address of at least a damaged memory block. In Step 220, according to the address of the damaged memory block in the SRAM unit 134, at least a redundancy block in the redundancy unit 136 corresponding to the damaged memory block is determined to replace the damaged memory block. Then, in Step 230, the address of the damaged memory block and the address of the corresponding redundancy block are stored in the memory unit 110, wherein the memory unit 110 may be a one time program memory in the present embodiment. Then, in Step 240, the external read/write unit 138 and the internal read unit 132 in the memory unit 130 read and write data from/to the SRAM unit 134 and the redundancy unit 136 according to the address data stored in the memory unit 110. Other details of the method have already been described in the embodiment of FIG. 1 and will not be repeated as they may be deduced by those of ordinary skill in the art according to the disclosure of the present invention.

Since the redundancy repair capability is used in the SRAM and the small-area one time program memory is employed to store relevant address data, the process yield of the SRAM is greatly enhanced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A memory, comprising:
a first memory unit, having a static random access memory (SRAM) unit and a redundancy unit; and
a second memory unit, coupled to the first memory unit;
wherein when the SRAM unit comprises at least one damaged memory block, a redundancy block in the redundancy unit corresponding to the damaged memory block is determined, and the address of the damaged memory block and the address of the redundancy block are stored in the second memory unit.

2. The memory as claimed in claim 1, wherein the first memory unit comprises an internal read unit coupled to the SRAM unit and the redundancy unit, and the internal read unit is adopted for reading data stored in the first memory unit for transmission to a display according to the address data stored in the second memory unit.

3. The memory as claimed in claim 1, wherein the first memory unit comprises an external read/write unit coupled to the SRAM unit and the redundancy unit, and the external read/write unit is adopted for determining address of reading and writing data from/to the first memory unit according to the address data stored in the second memory unit.

4. The memory as claimed in claim 1, wherein the second memory unit is a one time program memory.

5. The memory as claimed in claim 1, further comprising a built-in-self-test (BIST) unit for testing the address of the damaged memory block in the SRAM unit.

6. A redundancy repair method of a memory, the memory comprising a first memory unit and a second memory unit, the first memory unit comprises an SRAM unit and a redundancy unit, and the second memory unit is coupled to the first memory unit, the method comprising:
testing the SRAM unit;
wherein when the SRAM unit comprises at least one damaged memory block, a redundancy block in the redundancy unit corresponding to the damaged memory block is determined; and
storing the address of the damaged memory block and the address of the redundancy block.

7. The redundancy repair method of a memory as claimed in claim 6, wherein the step of testing comprises testing the SRAM unit by a BIST unit.

8. The redundancy repair method of a memory as claimed in claim 6, wherein the address of the damaged memory block and the address of the redundancy block are stored in the second memory unit.

9. The redundancy repair method of a memory as claimed in claim 8, wherein the second memory unit is a one time program memory.

10. The redundancy repair method of a memory as claimed in claim 6, wherein the first memory unit comprises an internal read unit coupled to the SRAM unit and the redundancy unit, and the read unit is adopted for reading data stored in the first memory unit for transmission to a display according to the address data stored in the second memory unit.

11. The redundancy repair method of a memory as claimed in claim 6, wherein the first memory unit comprises an external read/write unit coupled to the SRAM unit and the redundancy unit, and the external read/write unit is adopted for determining the address of reading and writing data from/to the first memory unit according to the address data stored in the second memory unit.
